(19) United States
(12) Patent Application Publication
(10) Pub. No.: US 2025/0051153 A1
(43) Pub. Date: Feb. 13, 2025

(54) CAMERA CRANE

(71) Applicant: Chapman/Leonard Studio Equipment, Inc., North Hollywood, CA (US)

(72) Inventors: Charles L. Huenergardt, Los Angeles, CA (US); Jason Sutton, Cumming, GA (US); Graham Baskett, Glendale, CA (US); Vacheh Akepian, Sunland, CA (US)

(21) Appl. No.: 18/447,570

(22) Filed: Aug. 10, 2023

(51) Int. Cl. B66F 11/04; F16M 11/04; F16M 11/12; F16M 11/18; F16M 11/42; G03B 17/56

(52) U.S. Cl. CPC B66F 11/048; F16M 11/048; F16M 11/126; F16M 11/18; F16M 11/42; G03B 17/561

(57) ABSTRACT

A mobile camera crane unit includes a camera crane having a column mounted on the chassis of a vehicle or mobile base. A drive system is configured to move the column linearly on the chassis between a use position at or near the back end of the mobile base, and a transport position further forward on the mobile base. A method of operating a camera crane unit of the type having a camera crane on a mobile base includes operating the mobile base to move the camera crane unit to a filming location with the camera crane in a transport position on the mobile base, moving the camera crane linearly to a use position spaced apart from the transport position and behind the transport position on the mobile base, and operating the camera crane.

### BACKGROUND OF THE INVENTION

Camera cranes are used to position and maneuver motion picture cameras, such as motion picture film, digital or video cameras, HD cameras, and 2D and 3D cameras. Camera cranes typically have a crane arm pivotally mounted on a column or post. The column is mounted onto a mobile base or vehicle having wheels. The camera crane and the mobile base together may be referred to as a mobile camera crane unit. The crane arm can be pivoted or tilted up or down, and panned from side to side, to obtain a desired camera position, while the mobile base remains stationary. Some crane arms can extend and retract with a telescoping movement. To follow a moving subject during filming, or to move the camera around a subject, the mobile base can be driven via an on-board electric or internal combustion motor. The mobile base often also serves as a highway road vehicle to transport the camera crane to the filming location.

Typically, the column of the camera crane is rigidly attached to the mobile base at a fixed position. As shown for example in U.S. Pat. No. 8,251,599, in most or all designs the fixed position is at the back end of the mobile base, near or directly over the rear axle of the vehicle. This design can provide for better positioning versatility in typical uses because it provides more clearance space between the back end of the crane and the chassis of the mobile base. It also reduces the potential interference of the cab or windscreen of the mobile base with movement or positioning of the front end of the camera crane. On the other hand, having the entire weight (e.g., 1000 kg, 2000 kg or more) of the camera crane loaded at the back of the mobile base can affect the balance, performance and handling of the mobile camera crane unit during highway driving. Accordingly, engineering challenges remain in the design of mobile camera crane units.

### SUMMARY OF THE INVENTION

A mobile camera crane unit includes a camera crane having a column mounted on the chassis of a vehicle or mobile base. A drive system is configured to move the column linearly on the chassis between a use position at or near the back end of the mobile base, and a transport position further forward on the mobile base. A method of operating a camera crane unit of the type having a camera crane on a mobile base includes operating the mobile base to move the camera crane unit to a filming location with the camera crane in a transport position on the mobile base, moving the camera crane linearly to a use position spaced apart from the transport position and behind the transport position on the mobile base, and operating the camera crane.

### BRIEF DESCRIPTION OF THE DRAWINGS

In the drawings, the same reference number indicates the same element in each of the views.

FIG. 1 is a side view of a camera crane on a mobile base in a storage or transport position.

FIG. 2 is a top view of the mobile base shown in FIG. 1 with the crane arm removed for purpose of illustration.

FIG. 3 is a side view of the camera crane and mobile base of FIG. 1 now in an in-use position.

FIG. 4 is a side view of an alternative mobile base having a chain drive system.

FIG. 5 is a partial top view of the mobile base of FIG. 4 with elements removed for purpose of illustration.

FIG. 6 is a perspective view of the chain drive system of FIG. 4.

### DETAILED DESCRIPTION

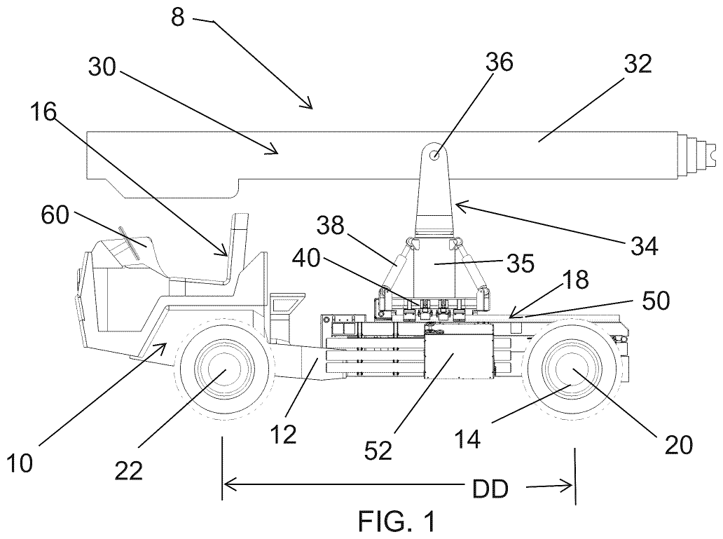

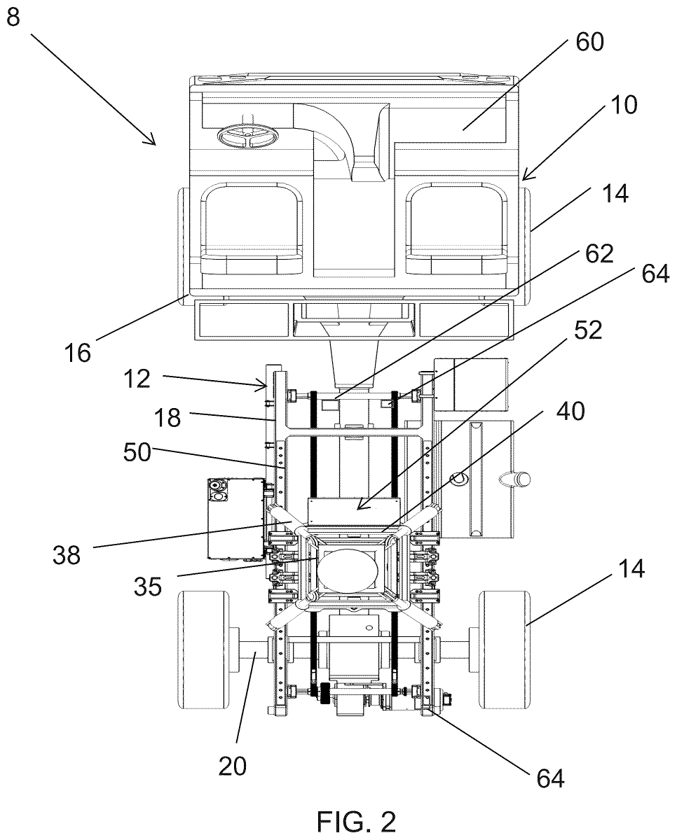

As shown in FIGS. 1 and 2, a mobile camera crane unit 8 includes a camera crane 30 and a mobile base or vehicle 10. The camera crane 30 may be a telescoping camera crane as described in U.S. Pat. No. 8,251,599, incorporated herein by reference. In this case the arm 32 of the camera crane 30 may telescope in and out, driven by an electric or hydraulic actuator. The camera crane 30 includes the crane arm 32, an upright 34, a column 35 and optionally a plate 40. The crane arm 32 is pivotally mounted on the U-shaped upright 34 by a pivot axle 36, allowing the arm 32 to tilt up and down. The upright 34 is rotatably mounted on the column 35, allowing the crane arm 32 to pan horizontally. The column 35 is supported on the plate 40, if used, optionally with levelling rods 38 extending from the top of the column 35 to the corners of the plate 40. The front end of the crane is configured for attaching a camera head or a camera platform, for example with attachment fittings. The remotely controlled camera 70 is attached onto a camera head or platform 72 which is pivotally attached to the front end of the crane arm 32. The camera platform 72 may have a self-leveling system to keep the camera platform level as the crane arm 32 pitches up and down.

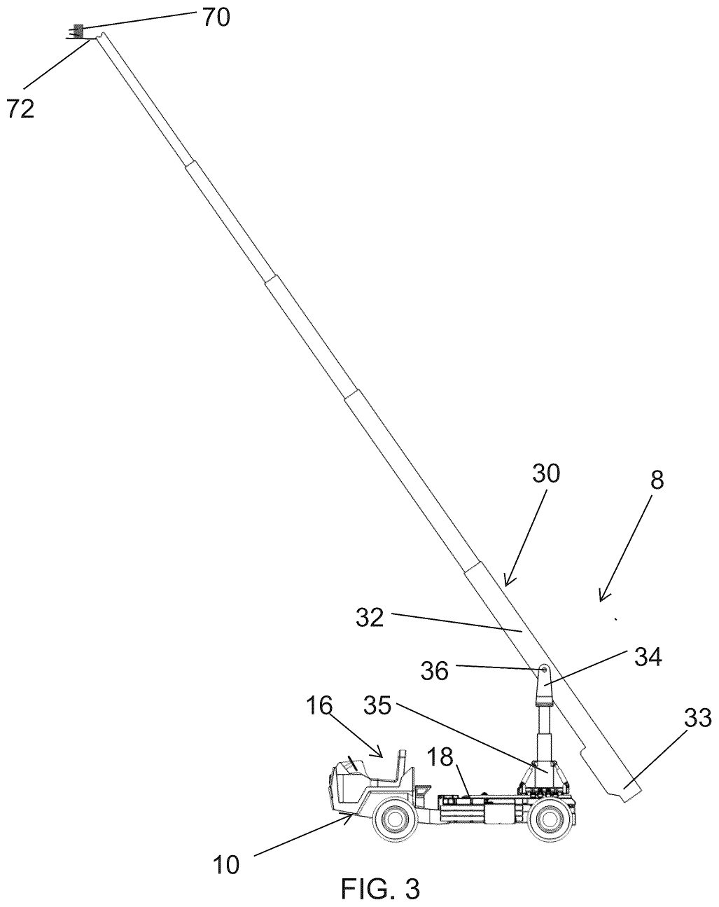

The mobile base or vehicle 10 may be a modified internal combustion engine heavy duty truck having wheels 14 on a chassis 12, optionally with added electric drive motors for silent low speed precision movement. The mobile base 10 may have an open or closed cab area 16 at the front of the chassis 12. The mobile base 10 may have all wheel drive and all wheel steering for increased off-road capability and maneuverability. The camera crane 30 is mounted on a deck 18 or rear surface of the chassis 12. A drive system 52 can move the camera crane 30 linearly from a first or transport position on the chassis 12 as shown in FIG. 1, to a second or use position as shown in FIG. 3. Dimension DD in FIG. 1 is the wheelbase or the dimension between the rear axle 20 and the front axle 22. The first position is e.g., at least 0.2 DD, 0.3 DD or 0.4 DD in front of the rear axle 20, and optionally near or at a longitudinal center of the wheelbase. The second position is adjacent to the rear axle 20 (e.g., within 0.1 DD or 0.2 DD) or is some designs directly over the rear axle 20. For mobile bases 10 having multiple rear axles, the dimensions above refer to the rear axle closest to the back end of the chassis.

In the second position as shown in FIG. 3, the camera crane 30 has greater flexibility in movement and positioning because the back end 33 of the crane arm 32 can pivot to a position below the level of the deck 18, and the cab area 16, if any, is less likely to interfere with movement of the front end of camera crane 30. In the second position the center of mass of the entire mobile camera crane unit 8 is shifted towards the back end of the chassis. In the first position the center of mass of the entire mobile camera crane unit 8 is more substantially centered between the front axle 22 and the rear axle 20. In the first position, the mobile crane unit 8 is better balanced and can provide better stability and road handling during highway driving. Consequently, the camera crane 30 is typically put into the second position during use, and into the first position during transit.

The distance between the first and second positions, or the range of longitudinal travel of the camera crane 30 on the mobile base 10 varies with the size of the camera crane 30. For example, a camera crane 30 having a maximum reach (from the pivot axle to the front end) of 5.8 meters may be used on a mobile base 10 providing a range of travel of about 2.4 to 3.8 meters. A camera crane 30 having a maximum reach of 22 meters may be used on larger mobile base 10 providing a range of travel of about 3 or 4 to 10 meters.

The drive element or system 52 may be provided as a servo motor, a winch, a hydraulic cylinder, a lead screw, an electric linear actuator, rack and pinion gears, or other elements for providing linear movement. A first end of the drive element 52 may be attached to the chassis 12 and a second end of the drive element is attached to the column 35, or to the plate 40, if used. If a servo motor or winch is used, it may operate by pulling on cables or chains attached to opposite sides of the column 35 or the plate 40. The column 35 or plate 40 may have rollers or bushing mounts engaged on rails 50 on the deck 18 to allow the camera crane 30 to roll or slide longitudinally between the first and second positions via the drive system 52, while preventing lateral or vertical movement between the camera crane 30 and the mobile base 10. Alternatively, the column 35 or the plate 40 may be mounted on roller wheels captive in tracks on the deck 18. Lockouts, such as pins or clamps may be provided to temporarily lock the camera crane 30 into a desired position. In smaller and lighter embodiments, the drive element 52 may be a manually operated crank, wheel or lever system.

A computer controller 60 may be used to control the drive element 52, for example a servo system, which longitudinally moves the camera crane 30 on the mobile base 10. A touchscreen and/or physical switches may be used to provide user inputs to the control computer 60. An encoder 62 may be used to measure the position of the camera crane 30 along its range of travel. Limit switches 64 provide additional feedback for the computer controller 60 and can provide automatic shut off at end of travel positions. If the camera crane 30 includes a telescoping crane arm 32, the computer controller 60 may also be electrically connected to the crane arm 32 and configured to also control telescoping movement of the crane arm 32. In this case, the computer controller 60 may be used to sequentially or simultaneously move the crane arm 32 longitudinally on the mobile base 10, and extend or retract the telescoping crane arm 32, typically while the mobile base 10 is stationary. The computer controller includes a memory configured to store programming for movement of the camera crane 30 on the mobile base 10 and optionally also telescoping movement of the telescoping crane arm. This allows single or combined movement sequences to be automatically and precisely repeated.

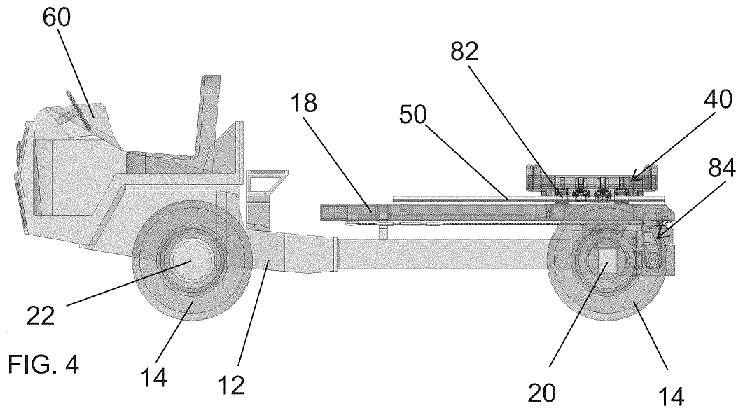

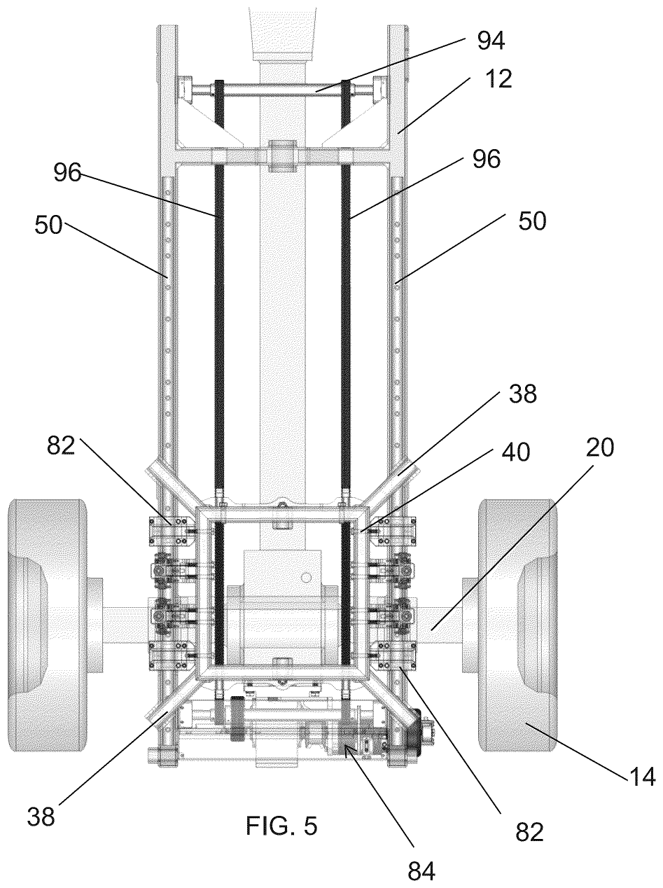

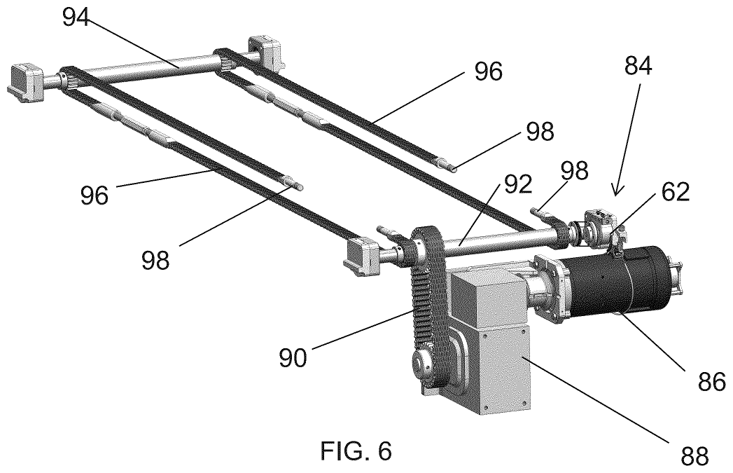

FIGS. 4-6 show an alternative design having a chain drive system 84 and rollers or sliders 82 for longitudinally rolling or sliding the plate 40 of the crane 30 on rails 50 supported on the deck 18 of the chassis 12 of a mobile base 80. As shown in FIG. 6, the chain drive system 84 may include first and second laterally spaced apart plate chains 96 extending around gears or sprockets on a drive axle 92 and an idler axle 94. A motor 86 rotates the drive axle 92 via a gear reduction unit 88 and a drive chain 90. Fittings 98 at the ends of the plate chains 96 are attached to opposite sides of the plate 40. Operating the motor 86 moves the camera crane 30 on the plate 40 between the first and second positions.

As used here, attached means mechanically connected directly or indirectly, i.e., optionally with one or more intermediate elements between the attached elements. From the foregoing, it will be appreciated that specific embodiments of the invention have been shown and described for purpose of illustration, but that various modifications may be made without deviating from the spirit and scope of the invention. Accordingly, the invention is not limited except to the following claims, and their equivalents.

1. A mobile camera crane unit, comprising:
a mobile base having wheels mounted on a chassis;
a camera crane having a column on the chassis;
a crane arm pivotally attached to the column, a front end of the crane arm configured to attach to a camera head or a camera platform;
levelling rods pivotally attached to the column for levelling the column; and
a drive system configured to move the column linearly on the chassis.

2. The mobile camera crane unit of claim 1 wherein the drive system comprises rails on a deck of the chassis, the column mounted on a plate slidably positioned on the rails; and the levelling rods attached to the plate.

3. The mobile camera crane unit of claim 1 wherein the drive system comprises a drive system including an electric motor configured to move the column longitudinally by pulling on one or more cables or chains.

4. The mobile camera crane unit of claim 1 wherein the drive system comprises a hydraulic or electric linear actuator having a first end attached to the chassis and a second end attached to the column.

5. The mobile camera crane unit of claim 1 wherein the drive system comprises a gear rack on the column and a pinion gear rotated by an electric motor on the chassis.

6. The mobile camera crane unit of claim 3 wherein the drive system includes a first cable or chain attached to a first side of the camera crane and a second cable or chain attached to a second side of the camera crane.

7. The mobile camera crane unit of claim 1 wherein the column is supported on rollers engaged with a track on the chassis.

8. The mobile camera crane unit of claim 2 wherein the mobile base has a wheelbase DD between front and rear axles, and the column is movable via the drive system from a first position at least 0.3 DD in front of the rear axle, to a second position within 0.1 DD of the rear axle, a back end of the crane arm pivotable to a position below the deck when the column is in the second position.

9. The mobile camera crane unit of claim 2 further including a computer controller electrically connected to the drive system and configured to control movement of the column on the chassis; an encoder electrically connected to the computer controller, the encoder configured to measure a longitudinal position of the column on the rails.

10. The mobile camera crane unit of claim 9 wherein the camera crane includes a telescoping crane arm and the computer controller is also configured to control telescoping movement of the telescoping crane arm.

11. The mobile camera crane unit of claim 10 wherein the computer controller includes a memory configured to store programming for movement of the column on the chassis and telescoping movement of the telescoping crane arm.

12. The mobile camera crane unit of claim 1 wherein the camera crane includes a crane arm pivotally mounted on a U-shaped upright by a pivot axle to allow the crane arm to tilt up and down, and the U-shaped upright is rotatably mounted on the column to allow the crane arm to pan horizontally, further comprising a remotely-operated camera head or camera platform pivotally attached to a front end of the crane arm.

13-16. (canceled)

17. A method of operating a camera crane unit having a camera crane on a mobile base, comprising:
operating the mobile base to move the camera crane unit to a filming location with the camera crane in a first position on a deck of the mobile base;
with the mobile base stationary, moving the camera crane linearly to a second position spaced apart from the first position and behind the first position on the mobile base;
operating the camera crane by tilting a crane arm of the camera crane so that a back end of the crane arm is below the deck; and
operating a camera supported on at a front end of the crane arm.

18. The method of claim 17 further including moving the camera crane linearly by using a computer controller electrically connected to a drive element on the mobile base and mechanically connected to a column of the camera crane.

19. The method of claim 18 wherein the camera crane is a telescoping camera crane, further comprising using the computer controller to control telescoping movement of the camera crane.

20. A mobile camera crane unit, comprising:
a mobile base having wheels mounted on front and rears axles on a chassis having a wheelbase DD;
a camera crane including a crane arm pivotally mounted on a U-shaped upright by a pivot axle to allow the crane arm to tilt up and down, and the U-shaped upright is rotatably mounted on a column to allow the crane arm to pan horizontally, further comprising a remotely-operated camera head or a camera platform pivotally attached to a front end of the crane arm;
the column mounted on a plate movable longitudinally on rails on a deck of the chassis;
levelling rods attached to the plate and to the column;
a drive system configured to move the column linearly on the chassis, the drive system including a motor configured to move the column longitudinally on the rails from a first position at least 0.4 DD in front of the rear axle to a second position within 0.1 DD of the rear axle, a back end of the crane arm pivotable to a position below the deck when the column is in the second position; and
a computer controller electrically connected to the drive system and configured to control longitudinal movement the column, and an encoder electrically connected to the computer controller, the encoder configured to measure a longitudinal position of the column on the rails.

21. The mobile camera crane unit of claim 20 wherein the drive system includes a first cable or chain attached to a first side of the camera crane and a second cable or chain attached to a second side of the camera crane.

22. The mobile camera crane unit of claim 20 wherein the camera crane includes a telescoping crane arm and the computer controller is also configured to control telescoping movement of the telescoping crane arm.

23. The mobile camera crane unit of claim 22 wherein the computer controller includes a memory configured to store programming for movement of the column and telescoping movement of the telescoping crane arm.
